(19) United States
(12) Patent Application Publication
(10) Pub. No.: US 2002/0121756 A1
(43) Pub. Date: Sep. 5, 2002

(54) SCOOTER REAR WHEELS PROVIDED WITH SUSPENSION MECHANISM

(76) Inventors: Cheng Lai Chen, Taichung (TW); Wu-Yon Lin, Taichung (TW)

Correspondence Address: Cheng Lai Chen, P.O. Box 453, Taichung, TW

(21) Appl. No.: 09/788,584

(22) Filed: Feb. 21, 2001

(51) Int. Cl. B62M 1/00

(52) U.S. Cl. 280/87.041

(57) ABSTRACT

A scooter comprises a footboard, two rear wheels, and a suspension mechanism which is mounted between the rear end of the footboard and the two rear wheels and is formed of a suspension main body, two shock-absorbing devices, and a braking device.

### FIELD OF THE INVENTION

The present inventional relates generally to a scooter, and more particularly to a rear wheels of the scooter, which are provided with a suspension mechanism.

### BACKGROUND OF THE INVENTION

The conventiona scooters are generally provided with only one rear wheel. However, the current tendency is such that a scooter with two rear wheels is gaining popularity. The scooter with two rear wheels is safer when the scooter is negotiating a sharp curve. In light of the two rear wheels of the conventional scooters being pivoted to the scooter footboard, the rear wheels are apt to swivel aside at the time when the scooters are negotiating a curve. Under such a circumstance as described above, the scooters in motion are susceptible to overturn. In addition, the body design of the conventional scooters stresses the shock-absorbing capability of the front wheel. In fact, when a scooter in motion is encountered with a bumpy surface, the vibration of the rear wheels is transmitted to the scooter footboard, thereby resulting in a rough ride.

### SUMMARY OF THE INVENTION

The primary objective of the present invention is to provide a scooter with a suspension mechanism which is mounted between the rear end of a scooter footboard and two rear wheels of the scooter. The suspension mechanism is formed of a suspension main body, two shock-absorbing devices, and a braking device.

The features, functions and advantages of the present invention will be more readily understood upon a thoughtful deliberation of the following detailed description of the present invention with reference to the accompanying drawings.

### BRIEF DESCRIPTION OF THE DRAWINGS

FIG. 1 shows a perspective view of scooter rear wheels of the present invention.

FIG. 2 shows an exploded view of the present invention.

FIG. 3 shows a top plan view of the present invention in combination.

FIG. 4 shows a side sectional view of the present invention in combination.

FIG. 5 shows a side sectional view of the shock-absorbing device of the present invention.

FIG. 6 shows a schematic rear view of the present invention in action.

FIG. 7 shows a schematic view of the shock-absorbing device of the present invention in action.

### DETAILED DESCRIPTION OF THE INVENTION

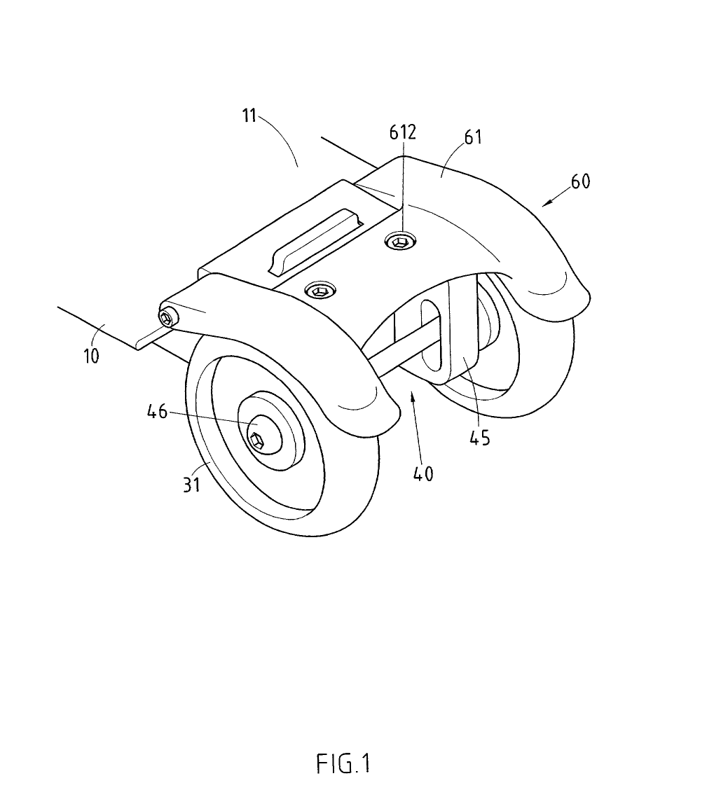

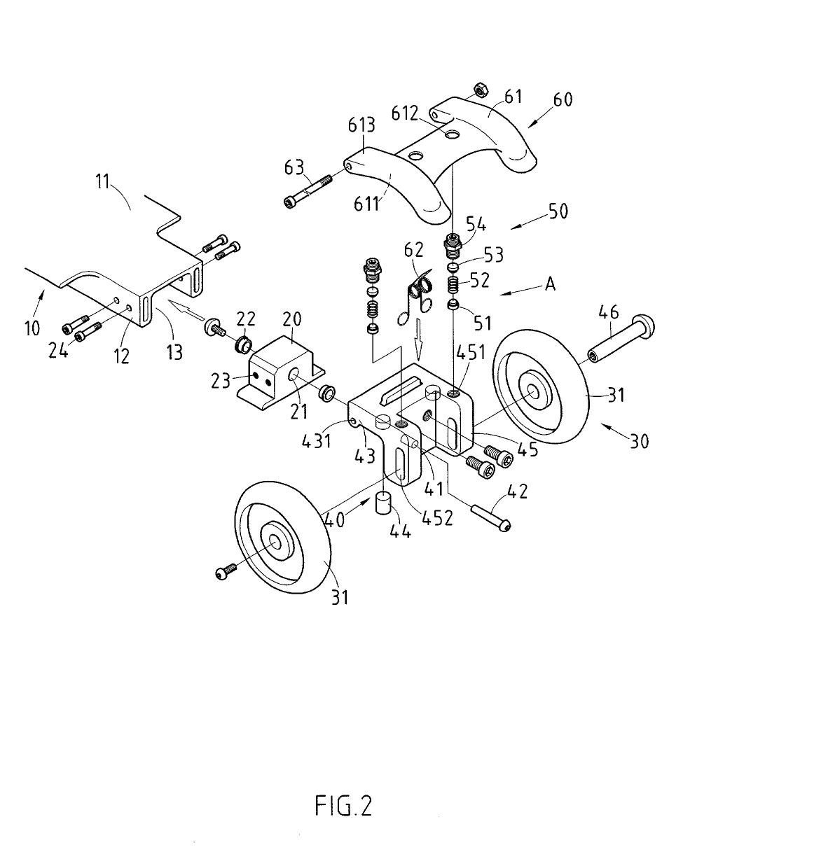

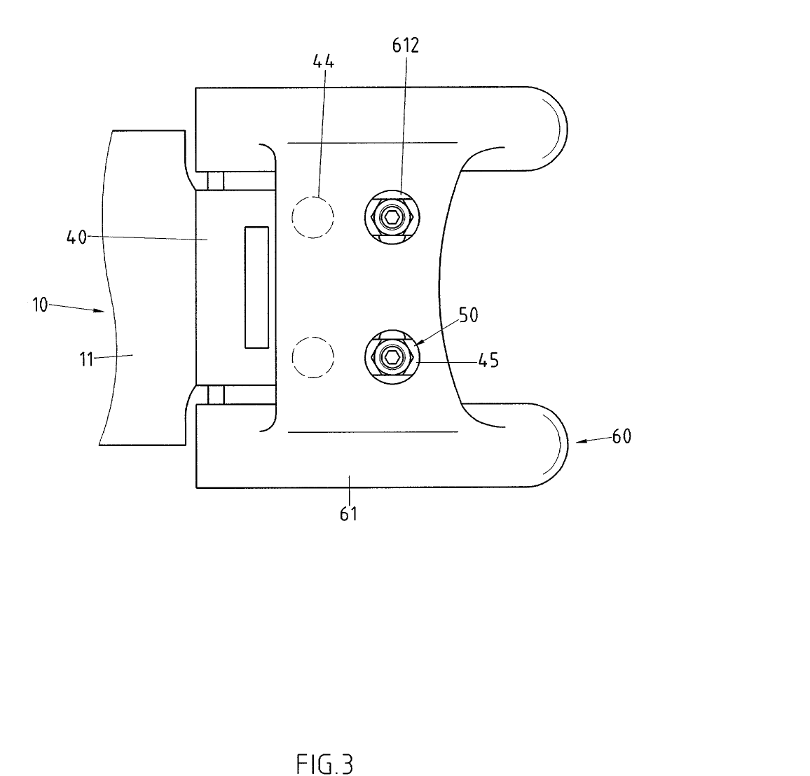

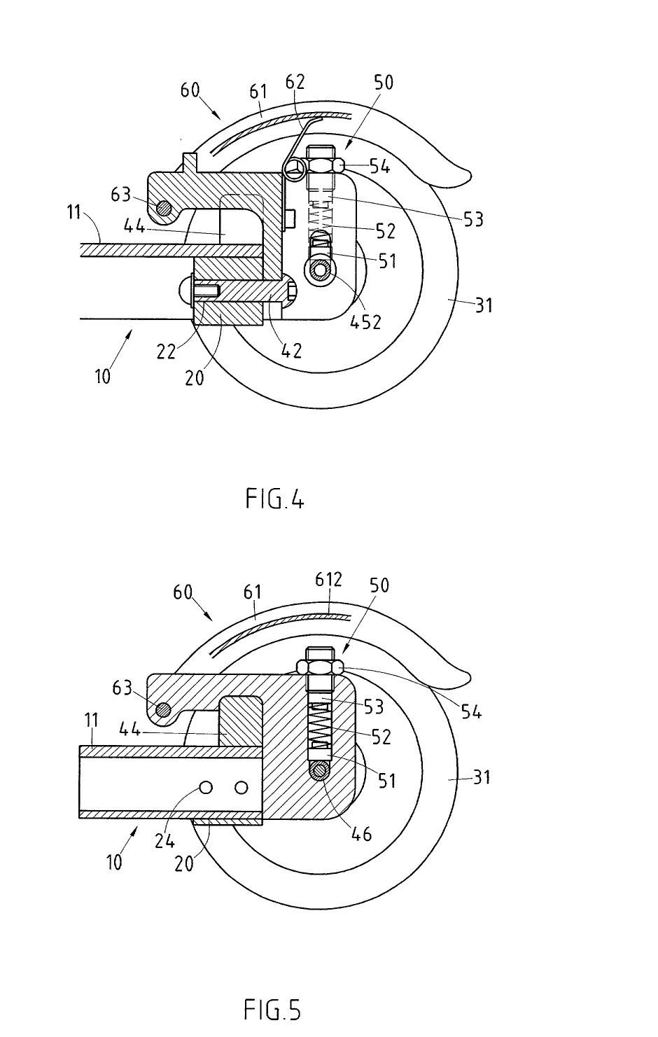

As shown in FIGS. 1-3, a scooter embodied in the present invention comprises a footboard 10, a fastening seat 20, a rear wheel set 30 having two rear wheels 31, and a suspension mechanism A which is formed of a suspension main body 40, two shock-absorbing devices 50, and a braking device 60.

The footboard 10 has a rear end 11 which is provided with two support ribs 12 and a receiving slot 13 located between the two support ribs 12 for mounting the fastening seat 20 by a plurality of fastening bolts 24. The fastening seat 20 is provided with an axial hole 21 and a plurality of threaded holes 23 which are engaged with the fastening bolts 24. The axial hole 21 is provided at both ends with a sleeve 22. The fastening seat 20 is used to fasten the suspension mechanism A of the present invention to the rear end 11 of the footboard 10 of the scooter of the present invention.

The suspension mechanism A of the present invention is formed of the suspension main body 40, the shock-absorbing device 50, and a braking device 60.

The suspension main body 40 is of an inverted U-shaped construction and is provided with a fastening hole 41 for fastening the suspension main body 40 to the rear end 11 of the scooter footboard 10 in conjunction with the fastening seat 20 and a fastening bolt 42 which is received in the fastening hole 41 of the suspension main body 40 and the axial hole 21 of the fastening seat 20. The suspension main body 40 is provided with a pivoting portion 43 facing the rear end 11 of the footboard 10, and two fastening portions 45 opposite to the pivoting portion 43. The fastening portions 45 are used to mount the rear wheel set 30. The pivoting portion 43 is provided with a pivoting hole 431 and two receiving slots 432 for accommodating an elastomer 44. The fastening portions 45 are provided at the top with an insertion slot 451 for disposing the shock-absorbing device 50. The fastening portions 45 are further provided with a guide slot 452 in communication with the insertion slot 451. An axle 46 is received in the guide slots 452. Two rear wheels 31 of the rear wheel set 30 are mounted on the axle 46.

The shock-absorbing device 50 comprises an urging block 51, a spring 52, a position-confining block 53, and an adjustable bolt 54. The shock-absorbing device 50 is disposed in the insertion slot 451 of the suspension main body 40 such that the urging block 51 urges the axle 46, and that the adjustable bolt 54 is engaged with the inner threads of the top end of the insertion slot 451. When the rear wheel 31 is in motion, the urging block 51 is caused by the vibration of the rear wheel 31 to compress the spring 52, thereby resulting in the shock absorbing effect. The torsion of the spring 52 can be adjusted by adjusting the adjustable bolt 54 in accordance with the extent of the vibration of the rear wheel 31.

The braking device 60 has an arcuate cover plate 61 which is formed of two arms parallel to each other, and a connection portion connecting the two arms. The two arms are provided in the underside with a braking portion 611 corresponding in location to the rear wheel 31. The connection portion is porvided with two through holes 612 corresponding in location to the insertion slots 451. The cover plate 61 is provided at the center of the underside with a recovery spring 62 which is fastened with the suspension main body 40 such that one end of the recovery spring 62 urges the underside of the cover plate 61. The two arms are provided with a pivoting end 613, which is fastened pivotally with the pivoting portion 43 of the suspension main body 40 by a pivot 63. As the cover plate 61 is exerted on by an external force, the two arms of the cover plate 61 are forced to move toward the rear wheels 31 in motion such that the braking portions 611 of the two arms come in contact with the rear wheels 31 in motion, so as to slow down or stop the rear wheels 31 by friction. As the cover plate 61 is relieved of the external force exerting thereon, the cover plate 61 is forced by the recovery spring 62 to return to its original position.

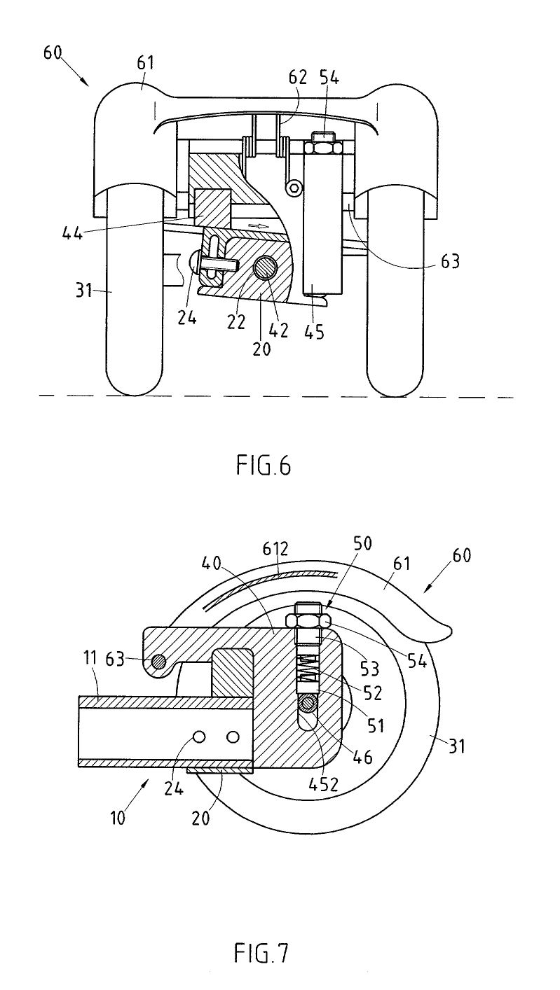

As illustrated in FIG. 6, when the scooter of the present invention in motion is tilted, the scooter footboard 10 and the fastening seat 20 are tilted together. In the meantime, both rear wheels 31 are in contact with the road surface. In addition, the two elastomers 44 are compressed by the footboard 10 and the suspension main body 40. As soon as the tilting of the scooter is brought to an end, the footboard 10 is assisted by the elastic recovery of the two elastomers 44 to remain in the horizontal position.

As shown in FIG. 7, when the scooter of the present invention in motion is encountered with a bumpy surface, the two shock-absorbing devices 50 work to alleviate the shock. In light of the axle 46 being urged by the urging blocks 51 of the shock-absorbing devices 50, the urging blocks 51 are caused by the vibration of the two rear wheels 31 to compress the springs 52 of the shock-absorbing devices 50, thereby resulting in the shock-absorbing effect. The torsion of the springs 52 can be adjusted in accordance with the extent of the vibration of the rear wheels 31 by turning the adjustable bolts 54 via the through holes 612 of the cover plate 61, as shown in FIG. 5.

The advantages of the present invention are numerous. In the first place, the suspension mechanism of the present invention enables the scooter footboard to tilt along with the center of gravity of the body of a person riding the scooter at the time when the scooter in motion is negotiating a sharp curve. In the meantime, the two rear wheels remain in contact with the road surface. When the scooter is operated on a bumpy surface, the shock-absorbing devices of the suspension mechanism of the present invention work to alleviate the shock of the two rear wheels. In addition, the torsion of the springs of the shock-absorbing devices can be adjusted with ease and speed. The scooter of the present invention is provided with a braking device which is simple in construction and is effective in braking the two rear wheels of the scooter of the present invention.

The embodiment of the present invention described above is to be regarded in all respects as being merely illustrative, and not restrictive. Accordingly, the present invention may be embodied in other specific forms without deviating from the spirit thereof. The present invention is therefore to be limited only by the scopes of the following appended claims.

What is claimed is:

1. A scooter comprising:
a footboard;
a fastening seat fastened with a rear end of said footboard;
a suspension mechanism pivoted to said fastening seat and formed of a suspension main body, two shock-absorbing devices, and a braking device, said suspension main body provided with a pivoting portion, two elastomers, two insertion slots, and two guide slots, said pivoting portion being fastened pivotally with said fastening seat such that said two elastomers urges said rear end of said footboard, said two shocking-absorbing devices being disoposed in said two insertion slots of said suspension main body, said braking device being pivoted to a top of said suspension main body and provided in an underside thereof with a recovery spring which is fixed on the top of said suspension main body; and
two rear wheels mounted on an axle which is received in said two guide slots of said suspension main body such that said axle is urged by said two shock-absorbing devices, said guide slots being in communication with said insertion slots in which said shock-absorbing devices are held.

2. The scooter as defined in claim 1, wherein said footboard is provided in an underside of the rear end thereof with two support ribs and a receiving slot located between said two support ribs; wherein
said fastening seat is disposed in said receiving slot of the rear end of said footboard.

3. The scooter as defined in claim 2, wherein said fastening seat is provided with a plurality of threaded holes and is fastened securely in said receiving slot of the rear end of said footboard by a plurality of fastening bolts which are engaged with said threaded holes of said fastening seat.

4. The scooter as defined in claim 1, wherein said shock-absorbing devices are formed of an urging block, a spring, a position-confining block, and an adjustable bolt, said shock-absorbing devices being disposed in said insertion slots of said suspension main body in such a manner that said urging block urges said axle, and that said shock absorbing devices are held securely in said insertion slots by said adjustable bolt whereby said adjustable bolt is engaged with inner threads of said insertion slot.

5. The scooter as defined in claim 4, wherein said spring is adjusted in torsion thereof by said adjustable bolt which is turned in said insertion slot.

6. The scooter as defined in claim 5, wherein said braking device is provided with two through holes corresponding in location to said two shock-absorbing devices;
wherein said adjustable bolt is turned in said insertion slot via one of said two through holes of said braking device.

7. The scooter as defined in claim 1, wherein said braking device has two braking portions corresponding in location to said two rear wheels.
